(19) United States
(12) Patent Application Publication
(10) Pub. No.: US 2012/0259595 A1
(43) Pub. Date: Oct. 11, 2012

(54) DEVICE LAYOUT MANAGEMENT APPARATUS, METHOD, AND STORAGE MEDIUM

(76) Inventor: Yoshihiro NARITA, Kanagawa (JP)

(21) Appl. No.: 13/427,196

(22) Filed: Mar. 22, 2012

(30) Foreign Application Priority Data
Apr. 7, 2011 (JP) 2011-085198

(51) Int. Cl. G06F 17/50

(52) U.S. Cl. 703/1

(57) ABSTRACT

A device layout management apparatus that has a layout drawing data processing unit that displays a layout drawing that includes the layout of a building network and the location of a device, based on layout drawing data and device data stored in a layout drawing data storage unit and a device data storage unit, respectively. A device data acquisition unit acquires device data stored in the device. A layout information comparing unit compares the acquired device data with either layout drawing data stored in the layout drawing data storage unit or device data stored in the device data storage unit, and determines whether the two sets of layout information coincide. If the layout information comparing unit determines that the two sets of layout information do not coincide, the layout information processing unit has the layout change reporting unit report that the layout of the device has changed.

### CROSS-REFERENCE TO RELATED APPLICATION

This patent application is based on and claims priority pursuant to 35 U.S.C. §119 to Japanese Patent Application No. 2011-085198, filed on Apr. 7, 2011, the entire disclosure of which is hereby incorporated by reference herein.

### BACKGROUND OF THE INVENTION

1. Field of the Invention

The present invention relates to a device layout management apparatus, a device layout managing method, and storage medium that stores a software program implementing the device layout managing method on a computer.

2. Description of the Related Art

Regarding a tool to manage a number of devices (management tool), a device layout management apparatus that manages layout of those devices by creating a layout drawing that includes the layout location of the devices and mapping those devices which are under the administration of the device layout management apparatus onto the layout drawing manually is commercially available.

As an example of this kind of device layout management apparatus, in order to save an administrator's labor, a management tool that collects layout information and revises the layout drawing on the management tool when the administrator changes layout information that shows the location of a device connected to a network manually is proposed (e.g., JP-2004-355503-A.)

However, the device layout management apparatus described in JP-2004-355503-A has a drawback in that the layout drawing is not revised if the layout information is not changed manually when the location of the device is changed.

### BRIEF SUMMARY OF THE INVENTION

The present invention provides a novel device layout management apparatus that prevents omitting to revise a layout drawing that includes information on layout location of devices. To achieve that purpose, the present invention implements a device layout management apparatus, a device layout managing method on the device layout management apparatus, and storage medium that includes a software program implementing the device layout managing method and to be executed on a computer, each described below.

The device layout management apparatus of the invention is communicably connected to a device and manages the layout of the device. The device layout management apparatus includes a layout drawing data storage unit that stores layout drawing data including location information of a building network, a device data storage unit that stores device data including the location of the device, a layout drawing display unit that displays the layout drawing, a layout drawing data processing unit that displays the layout drawing which includes layout location of the building network and layout location of the device based on the layout drawing data stored in the layout drawing data storage unit and the device data stored in the device data storage unit using the layout drawing display unit, a layout change reporting unit which reports that layout of the device has been changed, a device data acquisition unit that acquires the device data stored in the device, and a layout information comparing unit that compares device data acquired by the device data acquisition unit with either layout drawing data stored in the layout drawing data storage unit or device data stored in the device data storage unit and checks whether or not the layout information coincides. The layout information processing unit has the layout change reporting unit to report that the layout of the device has been changed in case the layout information comparing unit decides the layout information does not coincide.

Furthermore, the device layout management apparatus of the invention preferably has a layout drawing editing unit that edits the layout drawing displayed by the layout drawing display unit, and the layout drawing data processing unit edits the layout drawing displayed by the layout drawing display unit using the layout drawing editing unit after revising the layout drawing data stored in the layout drawing data storage unit and the device data stored in the device data storage unit based on the device data acquired by the device data acquisition unit in case the layout information comparing unit decides the layout information does not coincide.

In this case, the layout drawing data processing unit preferably has an editing unit that edits information on the layout drawing displayed by the layout drawing display unit using the layout drawing editing unit along with instruction externally, and a sending unit which notifies the device that information on the layout drawing has been changed by the layout drawing editing unit in case the layout drawing editing unit changed information on the layout drawing.

The device layout managing method includes a layout drawing data storage unit that is communicably connected to a device and stores layout drawing data including location information of the building network, a device data storage unit that stores device data including the location of the device, a layout drawing display unit that displays the layout drawing, and a layout change reporting unit which reports that layout of the device has been changed and manages layout of devices on the device layout management apparatus. Also the device layout managing method includes a layout drawing data processing step that displays the layout drawing which includes layout location of the building network and layout location of the device based on the layout drawing data stored in the layout drawing data storage unit and the device data stored in the device data storage unit using the layout drawing display unit, a device data acquiring step that acquires the device data stored in the device, and a layout information comparing step that compares device data acquired by the device data acquiring step with either layout drawing data stored in the layout drawing data storage unit or device data stored in the device data storage unit and checks whether or not the layout information coincides. In the layout information processing step, the layout change reporting unit reports that the layout of the device has been changed if it is decided that the layout information does not coincide in the layout information comparing step.

The storage medium of the invention is computer-readable and stores program code that implements a layout drawing data storing step that can communicate with a device and stores layout drawing data including location information of the building network, a device data storing step that stores device data including the location of the device, a layout drawing displaying step that displays the layout drawing, and a layout change reporting step which reports that layout of the device has been changed. Also the program of the invention implements a layout drawing data processing function that displays the layout drawing which includes layout location of the building network and layout location of the device based on the layout drawing data stored in the layout drawing data storing step and the device data stored in the device data storing step using the layout drawing displaying step, a device data acquiring function that acquires the device data stored in the device, and a layout information comparing function that compares device data acquired by the device data acquiring function with either layout drawing data stored in the layout drawing data storing step or device data stored in the device data storing step and checks whether or not the layout information coincides on a computer that manages layout of the device through steps described above. In the layout information processing function, the layout change reporting step reports that the layout of the device has been changed if it is decided that the layout information does not coincide by the layout information comparing function.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description when considered in connection with the accompanying drawings, wherein:

FIG. 1 is a diagram illustrating a configuration example of a device layout management apparatus as an embodiment of an information processing apparatus of the present invention;

FIG. 2 is a flow chart illustrating an example of a layout drawing revising process as a device layout managing process by a device layout management apparatus 10 shown in FIG. 1;

FIG. 3 is an explanatory diagram illustrating an example of a layout drawing displayed by a layout drawing display unit 17 shown in FIG. 1; and

FIG. 4 is an explanatory diagram illustrating revision of the layout drawing shown in FIG. 3.

### DETAILED DESCRIPTION OF THE PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

An embodiment of the present invention will be described in detail below with reference to the drawings. In the following embodiments, a system capability is described that detects physically a change of device layout and can predict the changed device location by comparing device data acquired from a device connected to a network (e.g. network information) with either layout drawing data that includes physical layout information of a building network that the system holds or device data that includes physical layout information of the device.

First, a configuration example of a device layout management apparatus as an embodiment of an information processing apparatus of the present invention will be described.

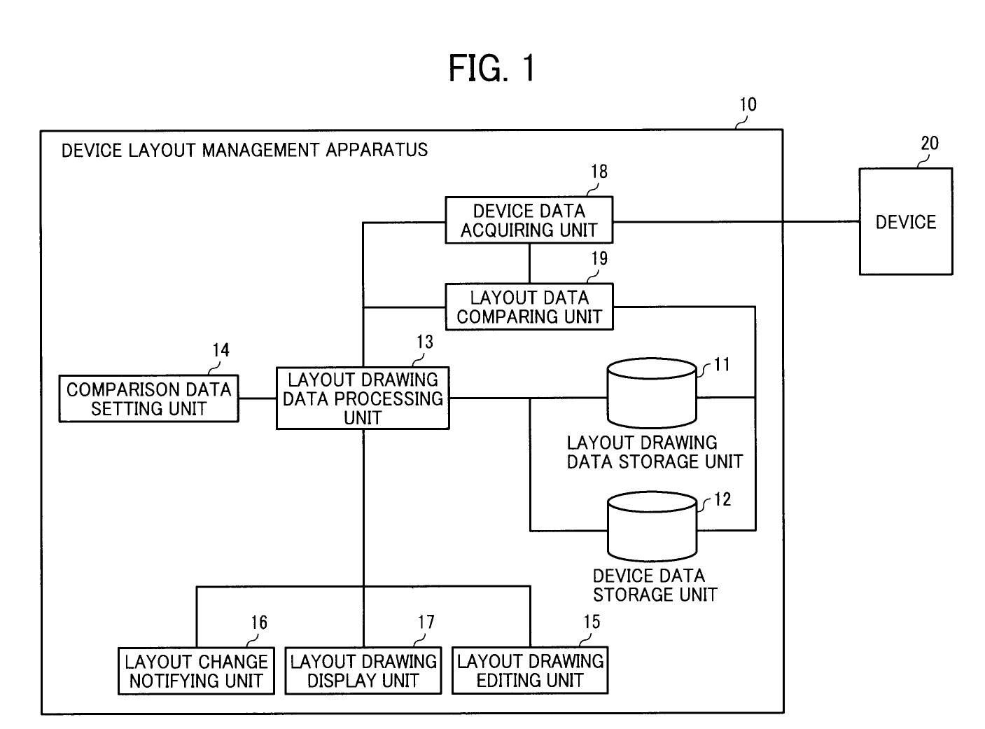

FIG. 1 is a diagram illustrating a configuration example of a device layout management apparatus. A device layout management apparatus 10 is implemented by information processing apparatuses (computers) such as personal computers.

The device layout management apparatus 10 is communicably connected to a device 20, and includes a layout drawing data storage unit 11, a device data storage unit 12, a layout drawing data processing unit 13, a compared information setting unit 14, a layout drawing editing unit 15, a layout change reporting unit 16, a layout drawing display unit 17, a device data acquisition unit 18, and layout information comparing unit 19.

The device 20 is an electronic device such as an image forming apparatus (e.g. a printer, digital copier, digital multifunctional peripheral, or facsimile machine.) The device 20 stores device data (layout drawing data for the device 20) including its identification data (e.g. name of the device) and layout information that indicates its layout location (e.g. network information) in a storage unit such as a flash memory or a hard disk drives (HDD.) The device 20 sends its device data to the device layout management apparatus 10 if the device 20 receives a request for its device data from the device layout management apparatus 10. The device 20 can also send its device data to the device layout management apparatus 10 without the request.

The layout drawing data storage unit 11 stores layout drawing data that includes physical layout location of a building network.

The device data storage unit 12 stores device data acquired form the device 20 by a device data acquisition unit 18 described in the following.

The layout drawing data processing unit 13 executes processing using layout drawing data. The following (a) to (d) is examples of processing using the layout drawing data.

(a) The layout drawing data processing unit 13 displays layout drawing that includes layout location of the building network based on layout information stored in the layout drawing information storage unit 11 and device data stored in the device data storage unit 12 using the layout drawing display unit 17.

(b) The layout drawing data processing unit 13 reports that the layout of the device 20 has been changed if a layout information comparing unit 19 described in the following identifies a discrepancy in layout information using the layout change reporting unit 16.

(c) The layout drawing data processing unit 13 revises layout drawing data stored in the layout drawing data storage unit 11 and device data stored in the device data storage unit 12 based on device data acquired by the device data acquisition unit 18, and edits layout drawing displayed by a layout drawing display unit 17 described below using the layout drawing editing unit 15 in case a discrepancy is identified.

(d) The layout drawing data processing unit 13 edits information on a layout drawing displayed by the layout drawing display unit 17 using the layout drawing editing unit 15 through instructions externally (via an input device such as a keyboard, not shown), and notifies the device 20 if information on the layout drawing has been changed using the layout change reporting unit 16.

The compared information setting unit 14 sets the kind of device data (acquired by the device data acquisition unit 18) to be compared with layout drawing data stored in the layout drawing data storage unit 11 by a layout data comparing unit 19 described below.

The layout drawing editing unit 15 edits layout drawing displayed by the layout drawing display unit 17.

The layout change reporting unit 16 reports that layout of the device 20 has been changed.

The layout drawing display unit 17 displays layout drawing on a display unit such as liquid crystal display (LCD) or cathode-ray tube (CRT), not shown.

The device data acquisition unit 18 acquires device data (e.g. network information) stored in the device 20 by sending a request for the device data to the device 20. The device data acquisition unit 18 also can acquire device data that the device 20 sends arbitrary.

The layout data comparing unit 19 compares device data acquired by the device data acquisition unit 18 with either layout drawing data stored in the layout drawing data storage unit 11 or device data stored in the device data storage unit 12, and decides whether the two sets of layout data coincide or not.

Among those units, the layout drawing data storage unit 11 and the device data storage unit 12 correspond to storage unit such as flash memory or HDDs. Also the layout drawing data processing unit 13, the compared information setting unit 14, the layout drawing editing unit 15, the layout change reporting unit 16, the layout drawing display unit 17, the device data acquisition unit 18, and the layout data comparing unit 19 are implemented as central processing unit (CPU) not shown in figures expands program stored in storage unit such as ROM, flash memory and HDD into RAM and executes the program.

Next, the process of revising a layout drawing using the device layout management apparatus 10 configured as shown above will be described below.

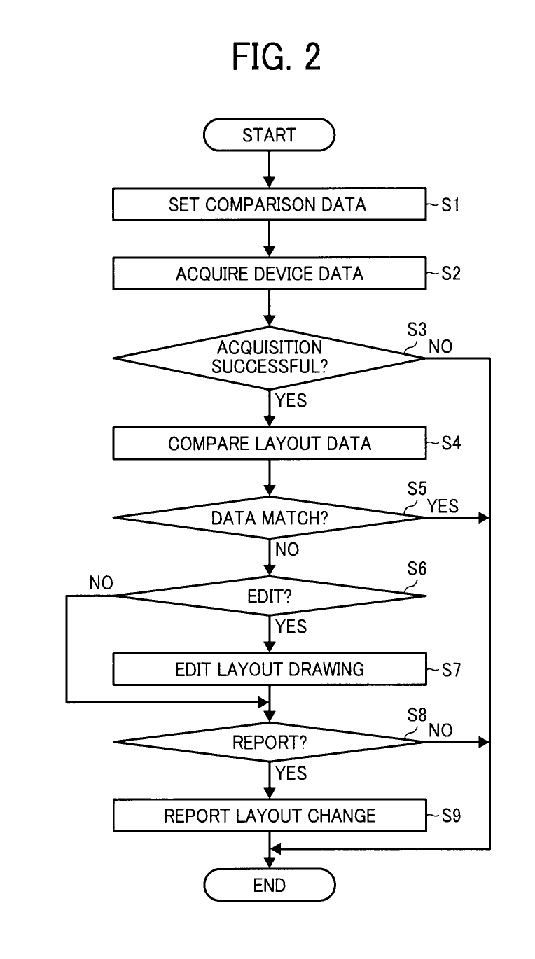

FIG. 2 is a flow chart that illustrates an example of the process of revising a layout drawing.

In this case, when the device layout management apparatus 10 is asked to display layout drawing externally (via a request input through an input unit such as a keyboard), a layout drawing display process routine is started by a call from a main routine, the device layout management apparatus 10 displays a layout drawing that includes the layout of the building network, and the device 20 based on layout drawing data stored in the layout drawing data storage unit 11 and device data stored in the device data storage unit 12 using the layout drawing display unit 17.

After that, the routine of the process of revising the layout drawing shown in FIG. 2 starts by calling from the main routine. Firstly, the kind of device data (such as network information) to be compared with layout drawing data stored in the layout drawing data storage unit 11 is determined and set in Step 1. One example of the network information is IP segment information (IP address.)

Next, the process proceeds to Step 2 and tries to acquire device data stored in the device 20 by asking the device 20 to send its device data whose kind was set in Step 1 to the device layout management apparatus 10. The device layout management apparatus 10 decides whether it succeeded in acquiring the device data or not in Step 3, and finishes the process of revising the layout drawing at the time in case it failed to acquire the device data.

If the device layout management apparatus succeeded in acquiring the device data from the device 20, it compares the device data with layout drawing data stored in the layout drawing data storage unit 11 inside the system in Step 4. Practically, it compares both sets of layout data. The layout data indicates in which place each segment (each group) of network is located on the corresponding floor in the building, and is equivalent to segment information (a part of IP address.) It should be noted that segment information of the device data acquired from the device 20 can be compared with segment information of the device data stored in the device data storage unit 12.

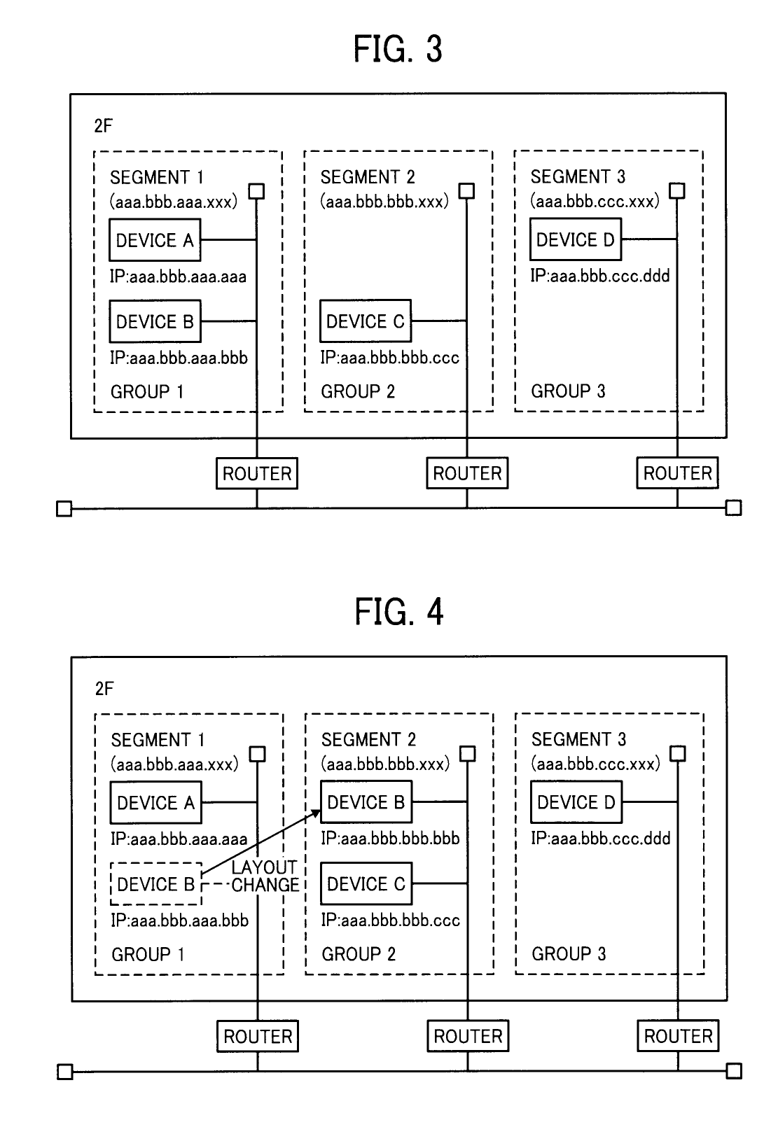

Now consider a case in which the layout drawing shown in FIG. 3 (it should be noted that the device 20 is equivalent to 4 devices, device A, B, C and D) is displayed by the layout drawing display unit 17, that is, the corresponding floor is the floor shown in FIG. 3 (the second floor.) In this case, the layout drawing data storage unit 11 stores a table of layout data shown in TABLE 1, and the device data storage unit 12 stores a table of device data shown in TABLE 2.

TABLE 1

| Segment | | | |
|---|---|---|---|
| information | Layout | Floor | Administrator |
| aaa.bbb.aaa | Group 1 | 2nd floor | admin 1 |
| aaa.bbb.bbb | Group 2 | 2nd floor | admin 2 |
| aaa.bbb.ccc | Group 3 | 2nd floor | admin 3 |

TABLE 2

| Device name | Address | Group | Floor | Administrator |
|---|---|---|---|---|
| Device A | aaa.bbb.aaa.aaa | Group 1 | 2nd floor | admin 1 |
| Device B | aaa.bbb.aaa.bbb | Group 1 | 2nd floor | admin 1 |
| Device C | aaa.bbb.bbb.ccc | Group 2 | 2nd floor | admin 2 |
| Device D | aaa.bbb.ccc.ddd | Group 3 | 2nd floor | admin 3 |

After comparing data in Step 4, the device layout management apparatus 10 proceeds to Step 5 and determines whether or not the layout data in device data acquired from the device 20 in Step 2 coincides with the layout data in the layout drawing data stored in the layout drawing data storage unit 11. The device layout management apparatus 10 finishes the process of revising the layout drawing if both sets of layout data coincide. If a difference between the two sets of layout data is detected, the device layout management apparatus 10 proceeds to Step 6 and determines whether it revises (edits) the layout drawing automatically or not. It should be noted that whether the device layout management apparatus 10 executes revising automatically or not is set by instruction externally (e.g. input device such as keyboard) in advance.

If the device layout management apparatus 10 determines not to revise layout drawing data automatically, it proceeds to Step 8 immediately and determines whether or not it notifies a user that it detects a difference in layout of the device 20 (i.e. layout of device 20 has been changed.) If the device layout management apparatus 10 does not report that it has identified a discrepancy between the two sets of data, it finishes the process of revising layout drawing. If the device layout management apparatus 10 does report that it has identified a discrepancy between the two sets of data, it proceeds to Step 9 and reports that it has detected a difference in layout of the device 20 to the user (actually it reports the discrepancy to a portable device such as a cell phone or an information processing apparatus such as a personal computer that the user utilizes) by sending an e-mail, recording log data into a nonvolatile memory such as a flash memory not shown in figures, or other methods. It should also be noted that whether or not the device layout management apparatus 10 reports that it has detected a difference in layout of the device 20 is set by instruction externally in advance.

By contrast, if the device layout management apparatus 10 determines that it revises layout drawing automatically in Step 6, it proceeds to Step 7 and causes the layout drawing editing unit 15 to edit the layout drawing displayed by the layout drawing display unit 17. For example, in case the layout of the device B is changed as shown in FIG. 4, the IP address of the acquired device data is “aaa.bbb.bbb.bbb” while the segment information of the device B stored in the layout drawing data storage unit 11 and shown in TABLE 1 is “aaa.bbb.aaa” and the IP address of the acquired device data is “aaa.bbb.bbb.bbb”. Therefore, the device layout management apparatus 10 determines that the two sets of layout data (segment information) do not coincide in Step 5 and causes the layout drawing editing unit 15 to edit layout drawing displayed by the layout drawing display unit 17 in Step 6.

In this case, the device layout management apparatus 10 determines that the device B has been moved to Group 2 by comparing layout data included in the new device data with segment information stored in the layout drawing data storage unit 11 and shown in TABLE 1 (or layout data in device data stored in the device data storage unit 12.) Then, the device layout management apparatus 10 deletes information of Group 1 from the layout drawing data and adds it to Group 2. That is, the device layout management apparatus 10 revises Group 1 information in the layout drawing data to Group 2 information.

Also, at the same time the device layout management apparatus 10 revises layout drawing data stored in the layout drawing data storage unit 11, it revises device data stored in the device data storage unit 12 too. For example, the device layout management apparatus 10 deletes Group 1 information from device data stored in the device data storage unit 12 and shown in TABLE 2, and adds it to Group 2. That is, the device layout management apparatus 10 revises Group 1 information in the device data to Group 2 information.

It should be noted that, according to instruction externally, the device layout management apparatus 10 can have the layout drawing editing unit 15 to edit information on the layout drawing displayed by the layout drawing display unit 17. In that case, if information on the layout drawing is changed (e.g. administrator information of the device 20 is changed due to replacement of administrator), the device layout management apparatus 10 can report that to the device 20 using the layout change reporting unit 16.

Also, a user who received notification that the difference in layout of the device 20 can have the layout drawing editing unit 15 edit the layout drawing by operating input devices (e.g., keyboards) of the device layout management apparatus 10, and can also indicate to the device layout management apparatus 10 to edit the layout drawing.

Furthermore, outside databases such as Windows™ Active Directory can be used as the layout drawing data storage unit 11 and the device data storage unit 12.

Accordingly, in this embodiment, a device layout management apparatus acquires device data stored in a device, compares the acquired device data with either layout drawing data stored in a layout drawing data storage unit or device data stored in a device data storage unit, determines whether the two sets of layout data coincide or not, and notifies a user that the layout of the device has been changed so that the device layout management apparatus can revise the layout drawing shown by a layout drawing display unit and include layout location of the device to prevent the layout drawing from omitting to revise.

In other words, if the device layout management apparatus determines that the two sets of layout data do not coincide, the device layout management apparatus also can revise layout drawing data stored in the layout drawing data storage unit and device data stored in the device data storage unit, and have the layout drawing editing unit edit (revise) the layout drawing displayed by the layout drawing display unit to ensure that the layout drawing is revised.

The software program used in this embodiment implements features such as a layout drawing data processing method, a device data acquiring method, and layout data comparing method on a device layout management apparatus (i.e., a CPU that controls the device layout management apparatus). That is, the features described above can be implemented by executing the program on the CPU.

This kind of program can be stored in a storage unit such as a ROM, nonvolatile memory (e.g. flash ROM or EEPROM), and HDD installed in the device layout management apparatus originally. It can also be stored on nonvolatile storage medium such as CD-ROM, memory card, flexible disk, MO, CD-R, CD-RW, DVD+R, DVD+RW, DVD-R, DVD-RW or DVD-RAM and provided to a user. The user can install the program stored on those kinds of storage media into the device layout management apparatus and have the CPU to execute the program, or have the CPU to read the program from those kinds of storage media and execute it to execute the processes described above. Furthermore, the user can have the CPU download the program from either external apparatus equipped with storage medium storing the program or external apparatus that stores the program in storage unit, and to execute the program.

As described above, the invention can prevent layout drawing including layout location of device from omitting to revise. Therefore the invention can provide a device layout management apparatus, a device layout managing method, and storage medium which stores a program that prevent layout drawing including layout location of device from omitting to revise.

As can be appreciated by those skilled in the computer arts, this invention may be implemented as convenient using a conventional general purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application specific integrated circuits or by interconnecting an appropriate network of conventional component circuits, as will be readily apparent to those skilled in the relevant art.

Numerous additional modifications and variations are possible in light of the above teachings. It is therefore to be understood that, within the scope of the appended claims, the disclosure of this patent specification may be practiced otherwise than as specifically described herein.

What is claimed is:

1. A device layout management apparatus, comprising:
a layout drawing data storage unit to store layout drawing data including location information of a network in a building;
a device data storage unit to store device data including a location of a device;
a layout drawing display unit to display the layout drawing;
a layout drawing data processing unit to display the layout drawing that includes layout of the network in the building and location of the device based on the layout drawing data stored in the layout drawing data storage unit and the device data stored in the device data storage unit using the layout drawing display unit;
a layout change reporting unit to report that the location of the device has been changed;
a device data acquisition unit to acquire the device data stored in the device; and
a layout information comparing unit to compare device data acquired by the device data acquisition unit with either layout drawing data stored in the layout drawing data storage unit or device data stored in the device data storage unit, and determine whether or not both sets of layout information coincide,
wherein the layout information processing unit has the layout change reporting unit report that the layout of the device has been changed in case the layout information comparing unit determines that both sets of layout information do not coincide.

2. The device layout management apparatus according to claim 1, further comprising a layout drawing editing unit to edit the layout drawing displayed by the layout drawing display unit,
wherein the layout drawing data processing unit edits the layout drawing displayed by the layout drawing display unit using the layout drawing editing unit after revising the layout drawing data stored in the layout drawing data storage unit and the device data stored in the device data storage unit based on the device data acquired by the device data acquisition unit in case the layout information comparing unit determines that both sets of layout information do not coincide.

3. The device layout management apparatus according to claim 2, further comprising:
an editing unit to edit information on the layout drawing displayed by the layout drawing display unit using the layout drawing editing unit along with instruction externally; and
a sending unit to notify the device that information on the layout drawing has been changed by the layout drawing editing unit in case the layout drawing editing unit changes information on the layout drawing.

4. A method of managing a device using a device layout management apparatus, comprising the steps of:
storing layout drawing data, including layout information of a building network, in a layout drawing data storage unit;
storing device data, including a location of a device, in a device data storage unit;
displaying the layout drawing which includes layout of the building network and location of the device based on the layout drawing data stored in the layout drawing data storage unit and the device data stored in the device data storage unit using the layout drawing display unit;
acquiring the device data stored in the device;
comparing device data acquired in the acquiring step with either layout drawing data stored in the layout drawing data storage unit or device data stored in the device data storage unit, and determining whether or not both sets of layout information coincide; and
reporting to the device layout management apparatus a change in the location of the device in a case in which it is determined in the comparing step that both sets of layout information do not coincide.

5. A non-transitory computer-readable storage medium storing a program that, when executed by a computer, causes the computer to implement a method of managing a device using a device layout management apparatus, the method comprising the steps of:
storing layout drawing data, including layout information of a building network, in a layout drawing data storage unit;
storing device data, including a location of a device, in a device data storage unit;
displaying the layout drawing which includes layout of the building network and location of the device based on the layout drawing data stored in the layout drawing data storage unit and the device data stored in the device data storage unit using the layout drawing display unit;
acquiring the device data stored in the device; and
comparing device data acquired in the acquiring step with either layout drawing data stored in the layout drawing data storage unit or device data stored in the device data storage unit, and determining whether or not both sets of layout information coincide.
